(19) United States
(12) Patent Application Publication
(10) Pub. No.: US 2019/0375682 A1
(43) Pub. Date: Dec. 12, 2019

(54) METHOD AND APPARATUS FOR PRODUCTION OF LIGHTWEIGHT AGGREGATES BY THERMAL TREATMENT IN A FLUIDIZED BED

(71) Applicant: Nautilus Aggregates, LLC, Concord, NC (US)

(72) Inventor: Andrew W. Castrodale, Concord, NC (US)

(21) Appl. No.: 16/143,553

(22) Filed: Sep. 27, 2018

Related U.S. Application Data
(60) Provisional application No. 62/681,374, filed on Jun. 6, 2018.

(51) Int. Cl. C04B 20/06; B01D 45/16; B01J 8/36; C04B 14/12; C04B 18/12; C04B 20/00

(52) U.S. Cl. CPC C04B 20/065; B01D 45/16; C04B 20/0016; C04B 14/12; C04B 18/125; B01J 8/36

(57) ABSTRACT

An apparatus for producing lightweight aggregates is provided that includes an elongate furnace vessel with a delivery end for receiving particulate matter feedstock to be processed and a downstream particulate matter discharge end for discharging processed particulate matter as lightweight aggregates. A perforated distributor plate is positioned in the vessel. A fluidized bed zone is defined above the plate that has an upstream heating section for converting the particulate matter into processed particulate matter due to exposure of pressurized combustion gases and a downstream cooling section for cooling the processed particulate matter. Below the plate is a heating compartment for delivering the combustion gases through the plate into the heating section and a cooling compartment for delivering cooling air through the plate into the cooling section to cool the particulate matter processed in the upstream heating section. A downstream airflow-inducing apparatus is provided for inducing a flow of the feedstock entrained in the airflow downstream from the heating section into the cooling section of the vessel. A discharge apparatus is provided for discharging the processed particulate matter from the vessel in a suspended condition in a fluidizing air stream.

### TECHNICAL FIELD AND BACKGROUND OF THE INVENTION

This invention relates to a method and apparatus for producing lightweight aggregates by treating materials such as slate, shale, clay, coal refuse, or coal combustion residuals (“CCR”) in a furnace which heats the material while suspended by pressurized air flow above a conveying platform. The material thus has minimal contact with the conveying platform during passage through the furnace. The method and apparatus of this application addresses processes for treating materials which are difficult to convey when heated because of their corrosive or adhesive qualities, among others. While the method and apparatus of the application have multiple uses, three primary applications are particularly relevant: (1) manufacture of lightweight aggregate (LWA); (2) manufacture of Portland cement; (3) processing of crushed stone fine aggregate, also known as manufactured sand, to produce larger gradation and/or less angular aggregate; and (4) manufacture of pozzolan with properties similar to coal combustion fly ash when used as a supplementary cementitious material (SCM) in concrete. This application discusses the production of lightweight aggregate as exemplary of the scope of the invention.

Existing methods of producing lightweight aggregate are inadequate for materials with corrosive or adhesive qualities. The properties of LWAs are related to the properties of the aggregates used for producing them, Generally, the strength and the density of concrete are considered when designing a structure. Specifically in the case of LWA, there is a wide variation in density and strength of LWA particles. The density of structural concrete produced using manufactured LWA is typically in the range of 1400 to 2000 kg/m3.

According to the production method, the lightweight aggregates (LWA) can be divided in two categories:
1. Natural Aggregates. Those occurring naturally and are ready to use only with mechanical treatment, i.e., crushing and sieving. They are taken from native deposits without any change in their natural states during production except for crushing, grading or washing. These natural aggregates include pumice and scoria.
2. Processed Aggregates. Those produced by thermal treatment from either naturally occurring materials or from industrial by-products, waste materials, etc.

The natural materials used for producing LWA of the second category include perlite and vermiculite, for example. Industrial by-products can also be used for producing LWA such as pulverized fly ash (PFA), CCR, blast furnace slag, and industrial waste sludge. These are produced by a process of either expansion (bloating) or agglomeration.

LWA is typically produced using a rotary kiln method, in which certain types of slate, shale or clay are fed into the kiln, heated to approximately 2000-2500 degrees F. The resulting product is cooled to ambient temperature and crushed to size.

LWA is used in many applications where lighter weight and other properties are valuable to the extent that the increased cost over normal weight aggregate alternatives is acceptable. These applications include but are not limited to concrete block, structural concrete (i.e. bridges, multi-story buildings, etc.), asphalt chip seal for road surfaces, geotechnical applications such as lightweight fill, fly ash replacement due to pozzolanic properties, internal curing due to absorptive properties, green roof and horticulture, and water treatment and filtration. LWA can be advantageous due to, among other reasons, reduced transportation costs, greater design efficiency and flexibility, and reduced construction timelines.

To induce the expansion of the raw material, most manufactured LWAs undergo some type of heat treatment during their manufacture. As mentioned above, the heat treatment used to manufacture LWA is typically performed in a rotary kiln, but various types of industrial furnaces could also be used, such as vertical shaft kilns, sinter strands, or foaming bed reactors. Expansion takes place when the material is heated to the fusion temperature at which point pyroplasticity of the material occurs simultaneously with the formation of gas bubbles (bloating). Agglomeration occurs when some material fuses, i.e., melts, and the various particles are bonded together.

A typical prior art rotary kiln used for manufacturing LWA is similar to the one used for manufacturing Portland cement which is a long cylinder lined with refractory bricks that is capable of rotating about its longitudinal axis, which is inclined at an angle of approximately 5 degrees to the horizontal. The length of the kiln depends upon the composition of the raw material to be processed and is usually 30 to 60 m. The prepared raw material is fed into the kiln at the higher end, while firing takes place at the lower end. As the material moves to the heating zone, the temperature of the particles gradually increases and expansion (bloating and density reduction) takes place. Burning and expanding are done at temperatures of about 1,000 to 1,200 C (1,800 to 2,200 F). Expanded material is then discharged into a cooler, where it is cooled by blowing air. Expansion depends upon the raw material and heating process. It is possible to produce LWA with varying bulk densities from the same raw material. Rotary kilns are very large and energy intensive devices up to 5 m in diameter and 70 m in length.

### SUMMARY OF THE INVENTION

Therefore, it is an object of the invention to provide a method and apparatus for producing lightweight aggregates with drastically smaller equipment size and lower energy use.

Therefore, it is an object of the invention to provide a method and apparatus for producing cement with drastically smaller equipment size and lower energy use.

It is another object of the invention to provide a method and apparatus for producing lightweight aggregates having a compact LWA production device that can be transported to the source of raw materials and processed on site, saving on transportation costs.

It is another object of the invention to provide a method and apparatus for producing lightweight aggregates that permits the density of LWA produced to be adjusted by varying operating conditions, such as temperature and heat treatment time in the apparatus.

It is another object of the invention to provide a method and apparatus for producing lightweight aggregates that permits agglomeration and thus creation of larger aggregates from small-size raw materials.

It is another object of the invention to provide a method and apparatus for producing lightweight aggregates that permits creation of stronger aggregates from weak quality aggregate through vitrification.

It is another object of the invention to provide a method and apparatus for producing lightweight aggregates that permit the use of coal mine tailings and potential use of the power plant coal ash to reduce remediation and clean-up costs.

These and other objects and advantages of the present invention are achieved in the preferred embodiments set forth below by providing an apparatus for producing lightweight aggregates that includes an elongate furnace vessel with a delivery end for receiving particulate matter feedstock to be processed and a downstream particulate matter discharge end for discharging processed particulate matter as lightweight aggregates. A perforated distributor plate is positioned in the vessel. A fluidized bed zone is defined above the plate that has an upstream heating section for converting the particulate matter into processed particulate matter due to exposure of pressurized combustion gases and a downstream cooling section for cooling the processed particulate matter. Below the plate is a heating compartment for delivering the combustion gases through the plate into the heating section and a cooling compartment for delivering cooling air through the plate into the cooling section to cool the particulate matter processed in the upstream heating section. A downstream airflow-inducing apparatus is provided for inducing a flow of the feedstock entrained in the airflow downstream from the heating section into the cooling section of the vessel. A discharge apparatus is provided for discharging the processed particulate matter from the vessel in a suspended condition in a fluidizing air stream.

According to another embodiment, the downstream airflow-inducing apparatus has a blower for delivering air through a heat exchanger and a burner adapted for combining and igniting fuel with the air from the heat exchanger and delivering resulting combustion gases to the heating compartment and through the perforations in the distributor plate into the heating section at a quantity and velocity sufficient to maintain the feedstock in a suspended condition in the combustion gases.

According to another embodiment, an air duet delivers cooling air from the blower upstream of the heating element to the cooling compartment.

According to another embodiment, a valve is positioned upstream of the heating and cooling compartments connecting the air duct and the combustion gases and is adapted for enabling the cooling air and combustion gases to mix and control the temperature of the combustion gases delivered to the heating compartment or the temperature of the cool air delivered to the cooling compartment.

According to another embodiment, the heating compartment has a plurality of compartments, each receiving combustion gases of respective predetermined temperatures.

According to another embodiment, the delivery end includes a feed hopper and a rotary valve to control the delivery of feedstock into the vessel.

According to another embodiment, the discharge apparatus includes a rotary valve for controlling the discharge of processed particulate matter.

According to another embodiment, a particulate control system is provided including an intake diverter duct positioned in the heating section for diverting a stream of particles below a predetermined size into the particulate control system, a cyclone apparatus connected to the intake diverter duct for removing fine particles from the diverted particle stream through vortex separation, passing the separated fine particles through an outlet for collection, and discharging a remaining filtered particle stream, and a discharge blower downstream of the cyclone apparatus for discharging the filtered particle stream.

According to another embodiment, the cyclone apparatus passes the separated fine particles back into the vessel downstream of the intake diverter duct.

According to another embodiment, the discharge blower is adapted to blow the filtered particle stream back into the vessel in the cooling section.

According to another embodiment, a heat exchanger is positioned between the cyclone and the discharge blower for cooling the filtered particle stream.

According to another embodiment, a bag house downstream of the cyclone is provided for receiving the filtered particle stream and filtering out additional particles of a finer granularity than the fine particles collected by the cyclone.

According to another embodiment, the baghouse is adapted to pass the additional particles back into the vessel downstream of the intake diverter duct.

According to another embodiment, a method for producing lightweight aggregates comprises the steps of first providing an elongate vessel having a delivery end and a downstream particulate matter discharge end, and a perforated distributor plate positioned in the vessel and defining above the plate a material zone having an upstream heating section and a downstream cooling section and defining below the plate a heating compartment and a cooling compartment. Then delivering particulate matter feedstock to be processed into the delivery end of the vessel at a predetermined rate and delivering combustion gases upward through the perforations in the distributor plate from the heating compartment into the heating section. Next, causing the feedstock to travel downstream in a suspended condition in a fluidizing air stream due to combustion gases delivered upward through the distributor plate and exposing the feedstock to the combustion gases for converting the feedstock into processed particulate matter. Lastly, cooling the fluidized air stream of the processed particulate matter in the cooling section by delivering cooling air into the cooling compartment, through the perforations in the distributor plate and finally into the fluidized processed particulate matter in the cooling section and discharging the processed particulate matter from the vessel from the discharge end.

According to another embodiment, a method for producing lightweight aggregates comprises the steps of first providing an elongate vessel having a delivery end and a downstream particulate matter discharge end, and a perforated distributor plate positioned in the vessel and defining above the plate a material zone having an upstream heating section and a downstream cooling section and defining below the plate a heating compartment and a cooling compartment. Then delivering particulate matter feedstock to be processed into the delivery end of the vessel at a predetermined rate, blowing ambient air through a heat exchanger to preheat the air, inserting fuel into the air, igniting the fuel and air to create combustion gases, and delivering combustion gases upward through the perforations in the distributor plate from the heating compartment into the heating section. Next, causing the feedstock to travel downstream in a suspended condition in a fluidizing air stream due to combustion gases delivered upward through the distributor plate and exposing the feedstock to the combustion gases for converting the feedstock into processed particulate matter. Lastly, cooling the fluidized air stream of the processed particulate matter in the cooling section by delivering cooling air into the cooling compartment, through the perforations in the distributor plate and finally into the fluidized processed particulate matter in the cooling section and discharging the processed particulate matter from the vessel from the discharge end.

### BRIEF DESCRIPTION OF THE DRAWINGS

FIG. 1 is a flow diagram of a method and apparatus for production of lightweight aggregates by thermal treatment in a fluidized bed of a furnace;

FIG. 2 is a top plan view of the perforated distributor plate;

FIG. 3 is a flow diagram of a method and apparatus for production of lightweight aggregates by thermal treatment in a fluidized bed of a furnace including a particulate control system;

FIG. 4 is a flow diagram of a method and apparatus for production of lightweight aggregates by thermal treatment in a fluidized bed of a furnace including a recirculating particulate control system;

FIG. 5 is a partial flow diagram of a method and apparatus for production of lightweight aggregates by thermal treatment in a fluidized bed of a furnace including a multiple compartment heating plenum; and

FIG. 6 is a flow chart showing the method for production of lightweight aggregates by thermal treatment in a fluidized bed of a furnace.

### DETAILED DESCRIPTION OF THE PREFERRED EMBODIMENT

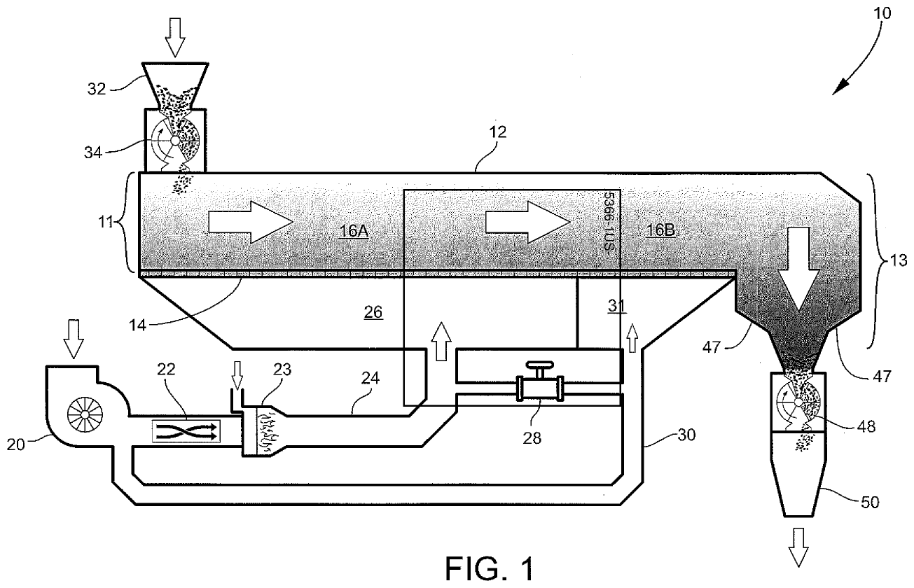

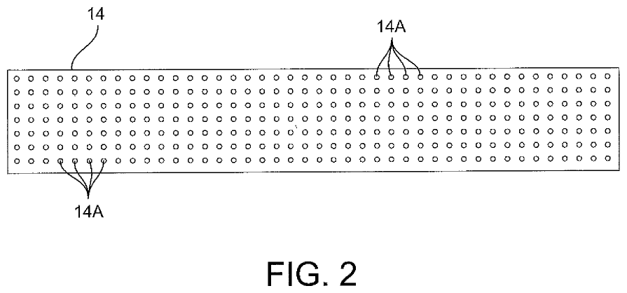

Referring now to the drawings, a furnace for the production of lightweight aggregates by thermal treatment in a fluidized bed according to one preferred embodiment of the invention is illustrated and indicated broadly at reference numeral 10 of FIG. 1. The furnace 10 includes a furnace vessel 12, which may be a cylindrical, rectangular or other shape. The vessel 12 has an upstream delivery end 11 and a downstream discharge end 13. A perforated distributor plate 14, shown in FIG. 2, is positioned in the vessel 12 below an upstream heating section 16A and a downstream cooling section 16B of the vessel 12. Together, the heating section 16A and the cooling section 16B make up a fluidized bed zone (16A, 16B). Below the distributor plate 14 is a plenum that has two compartments, a heating plenum compartment 26 and a cooling plenum compartment 31.

As is shown in FIG. 2, the perforations 14A of the distributor plate 14 provide a means of evenly dispersing combustion gases and cooler air into the heating section 16A and the cooling section 16B respectively through the distributor plate 14. The distributor plate 14 may be slightly angled downwardly in the downstream direction towards the cooling section 16B to promote downstream flow of the feedstock during processing in the vessel 12. Alternatively, the perforations of the distributor plate 14 may be angled through the distributor plate 14 in the downstream direction to promote downstream flow of the feedstock through the heating section 16A. A further alternative is to employ individually-angled air jets in the distributor plate 14 as a means of injecting combustion gases into the heating section 16A.

Temperature conditions necessary for processing the feedstock are created by a blower 20 that propels ambient air past a heat exchanger 22 where it is mixed with a fuel such as natural gas, ignited and delivered under pressure through a combustion duct 24 into the heating plenum compartment 26 that conveys the combustion gases under pressure across the surface area of the distributor plate 14 and through the perforations of the distributor plate 14 into the heating section 16A. A duct burner 23 ignites the fuel-air mixture. Other ignition systems and combustion systems are also interchangeable with the duct burner 23. The temperature of the combustion gases is regulated by a mixing valve 28 that mixes ambient air delivered by a cold air duct 30 from the blower 20 with the combustion gases from the combustion duct 24 and delivers the relatively cooler air to the cooling plenum compartment 31 positioned beneath the cooling section 16B.

The raw material is introduced into the delivery end 11 of the vessel 12 from a feed hopper 32 through, for example, a rotary valve 34 at a predetermined flow rate into the heating section 16A. The rotary valve 34 preferably includes an anti-backflow device that prevents combustion gases in the vessel 12 from being blown back upstream into the feed hopper 32. The feedstock expands in the heated environment of the heating section 16A and is maintained in a suspended condition or a ‘fluidized bed’ by the pressurized flow of combustion gases being propelled through the perforations in the distributor plate 14.

Feedstock in the vessel 12 is propelled along the length of the vessel 12 downstream from the heating section 16A into the cooling section 16B where a predetermined drop in temperature results from cooled air being propelled through the perforations of the distributor plate 14 in the cooling section 16B and into the suspended feedstock particles. Fluidizing air 47 is injected into the discharge end 13 of the cooling section 16B to maintain the particles in a suspended, separated and flowable condition. An optional discharge rotary valve 48 balances the outflow rate with the inflow rate of the feed hopper rotary valve 34 and controls the rate of discharge of the processed feedstock, now in the form of LWA product from the cooling section 16B, into a discharge hopper 50 for storage or delivery to further processing steps.

As the feedstock is moving downstream in the vessel 12, its temperature rapidly increases, before reaching a plateau and, eventually, the maximum temperature. Due to the high rate of mixing in the heating section 16A, the maximum temperature is slightly lower compared to the fluidization temperature, i.e., if fluidization is performed at 1,000 C, the maximum temperature will be very close to 1,100 C. Thus, a large portion of the heating section 16A will operate at a very high temperature. The resulting LWA has enhanced properties that permit it to be used as a concrete ingredient having correspondingly-enhanced properties, as described above.

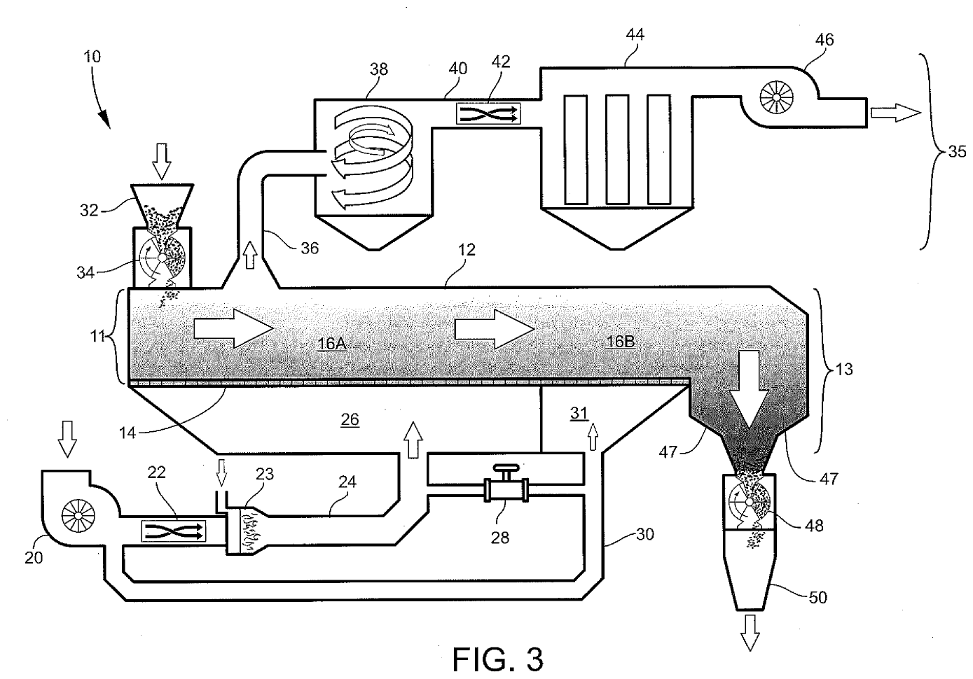

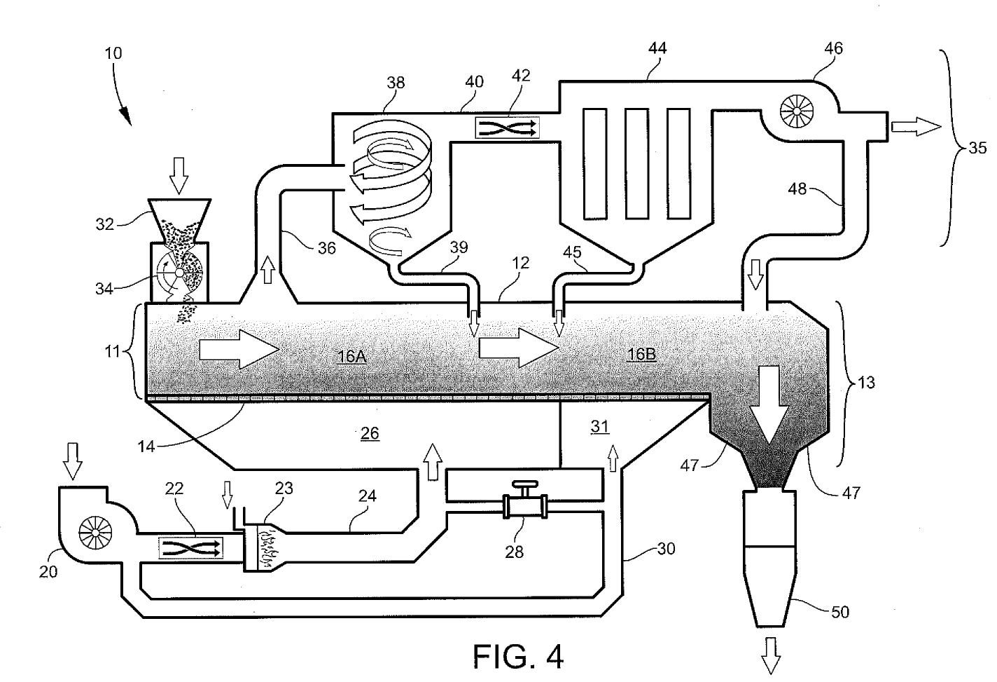

FIGS. 3 and 4 show the furnace 10 including a particulate control system 35. The particulate control system 35 can be non-recirculating as in the FIG. 3 embodiment, or recirculating as in the FIG. 4 embodiment. The particulate control system 35 may eliminate the need for the discharge rotary valve 48 to balance the outflow rate, especially in the recirculating particulate control system 35 shown in FIG. 4. Fine feedstock particles below a certain size are sucked into a diverter duct 36 and into a cyclone apparatus 38. The fine particles are then collected and used as fine LWA or will be injected into to the fluidized bed farther along in the heating section 16A by a cyclone recirculation duct 39 so that they agglomerate with the softened particle in the fluidized bed. The cyclone apparatus 38 will operate at a temperature close to the average temperature of the heating zone 16A.

Particles sufficiently fine that they remain below a certain small size in the cyclone apparatus 38 are conveyed from the cyclone apparatus 38 through a discharge duct 40 where they are cooled in a heat exchanger 42 and then conveyed into a discharge apparatus such as a bag house 44 where the particles are filtered from the air stream in which they are entrained. Particles filtered by the bag house 44 can be disposed, collected for use as fine LWA, or injected into the fluidized bed further along in the cooling section 16B by a bag house recirculation duct 45. The filtered air is discharged by a discharge fan 46 on the downstream side of the bag house 44 into ambient air, into further filters, may be used to fluidize the feed hopper 32 and the discharge hopper 50, or to cool other selected furnace components such as the discharge end 13 of the vessel 12 by way of a discharge cooling duct 48 (as shown in FIG. 4).

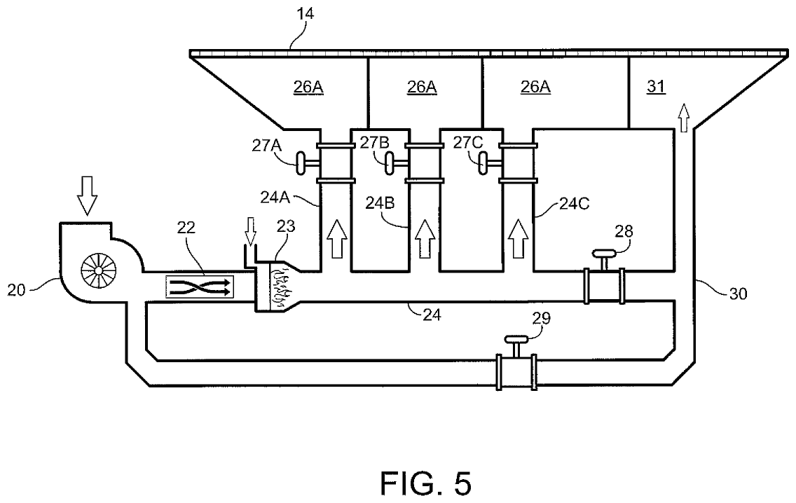

As shown in FIG. 5, another embodiment includes a plenum with more than two compartments, heating plenum compartments 26A, 26B, 26C and cooling plenum compartment 31. This configuration enables more control of the temperature in the fluidized bed along the length of the vessel 12. Each heating plenum compartment 26A, 26B, 26C is separately supplied combustion gases by its own respective combustion duct 24A, 24B, 24C. The temperature in each respective combustion duct 24A, 24B, 24C is controlled by a separate mixing valve 27A, 27B, 27C. The mixing valve 28 still controls the flow of cooling air from the cold air duct 30 and an optional cooling air control valve 29 controls the flow of cooling air to the cooling plenum compartment 31.

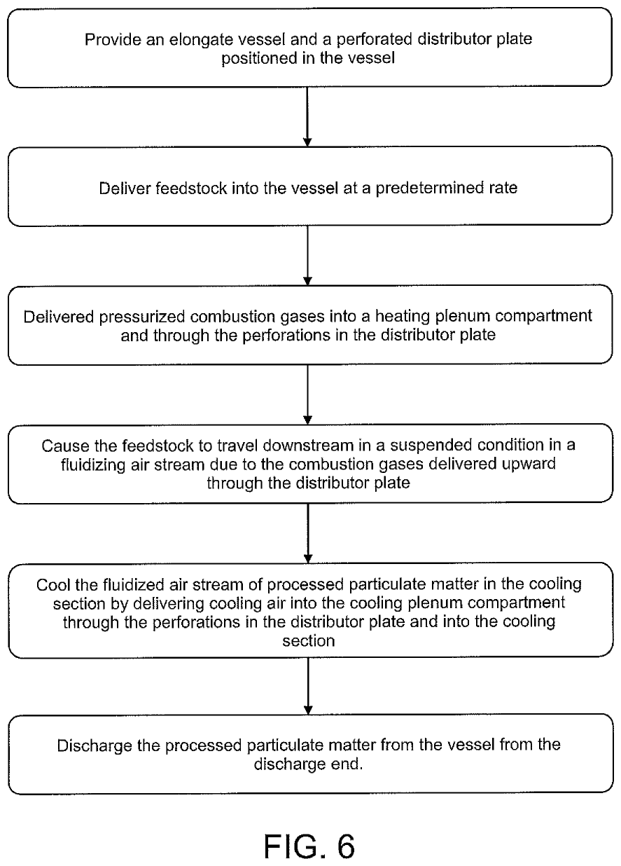

The flow chart of FIG. 6 outlines the steps of producing lightweight aggregates in a furnace 10 according to the preferred embodiment. Feedstock is delivered into the delivery end 11 of the vessel 12 where it is subjected to combustion gases that are delivered into the heating plenum compartment 26 of the vessel 12 and up through the perforations 14A of the distributor plate 14. The feedstock then becomes a fluidized bed that travels downstream inside the vessel 12 above the distributor plate 14 from the heating section 16A to the cooling section 16B. Cooler air is then introduced to the fluidized bed in the cooling section 16B. This cooler air comes from the ambient air blown by the blower 20, through the cooling air duct 30, into the cooling plenum compartment 31, and finally through the perforations 14A of the distributor plate 14 to the cooling section 16B. The processed particulate matter is then discharged from the vessel 12 at the discharge end 13.

A method and apparatus for producing lightweight aggregates according to the invention have been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

We claim:

1. An apparatus for producing lightweight aggregates, comprising:
(a) an elongate furnace vessel having a delivery end for receiving particulate matter feedstock to be processed and a downstream particulate matter discharge end for discharging processed particulate matter as lightweight aggregates;
(b) a perforated distributor plate positioned in the vessel and defining above the plate a fluidized bed zone having an upstream heating section for converting the particulate matter into processed particulate matter due to exposure of pressurized combustion gases and a downstream cooling section for cooling the processed particulate matter, and defining below the plate a heating compartment for delivering the combustion gases through the plate into the heating section and a cooling compartment for delivering cooling air through the plate into the cooling section to cool the particulate matter processed in the upstream heating section;
(c) a downstream airflow-inducing apparatus for inducing a flow of the feedstock entrained in the airflow downstream from the heating section into the cooling section of the vessel; and
(d) a discharge apparatus for discharging the processed particulate matter from the vessel in a suspended condition in a fluidizing air stream.

2. An apparatus for producing lightweight aggregates according to claim 1, wherein the downstream airflow-inducing apparatus includes:
(a) a blower for delivering air through a heat exchanger; and
(b) a burner adapted for combining and igniting fuel with the air from the heat exchanger and delivering resulting combustion gases to the heating compartment and through the perforations in the distributor plate into the heating section at a quantity and velocity sufficient to maintain the feedstock in a suspended condition in the combustion gases.

3. An apparatus for producing lightweight aggregates according to claim 2, wherein an air duct delivers cooling air from the blower upstream of the heating element to the cooling compartment.

4. An apparatus for producing lightweight aggregates according to claim 3, wherein a valve is positioned upstream of the heating and cooling compartments connecting the air duct and the combustion gases and is adapted for enabling the cooling air and combustion gases to mix and control the temperature of the combustion gases delivered to the heating compartment or the temperature of the cool air delivered to the cooling compartment.

5. An apparatus for producing lightweight aggregates according to claim 1, wherein the heating compartment has a plurality of compartments, each receiving combustion gases of respective predetermined temperatures.

6. An apparatus for producing lightweight aggregates according to claim 1, wherein the delivery end includes a feed hopper and a rotary valve to control the delivery of feedstock into the vessel.

7. An apparatus for producing lightweight aggregates according to claim 1, wherein the discharge apparatus includes a rotary valve for controlling the discharge of processed particulate matter.

8. An apparatus for producing lightweight aggregates according to claim 1, further comprising a particulate control system including:
(a) an intake diverter duct positioned in the heating section for diverting a stream of particles below a predetermined size into the particulate control system;
(b) a cyclone apparatus connected to the intake diverter duct for removing fine particles from the diverted particle stream through vortex separation, passing the separated fine particles through an outlet for collection, and discharging a remaining filtered particle stream; and
(c) a discharge blower downstream of the cyclone apparatus for discharging the filtered particle stream.

9. An apparatus for producing lightweight aggregates according to claim 8, wherein the cyclone apparatus passes the separated fine particles back into the vessel downstream of the intake diverter duct.

10. An apparatus for producing lightweight aggregates according to claim 8, wherein the discharge blower is adapted to blow the filtered particle stream back into the vessel in the cooling section.

11. An apparatus for producing lightweight aggregates according to claim 8, further comprising a heat exchanger positioned between the cyclone and the discharge blower for cooling the filtered particle stream.

12. An apparatus for producing lightweight aggregates according to claim 8, further comprising a bag house downstream of the cyclone for receiving the filtered particle stream and filtering out additional particles of a finer granularity than the fine particles collected by the cyclone.

13. An apparatus for producing lightweight aggregates according to claim 12, wherein the baghouse is adapted to pass the additional particles back into the vessel downstream of the intake diverter duct.

14. A method for producing lightweight aggregates, comprising the steps of:
(a) providing:
i. an elongate vessel having a delivery end and a downstream particulate matter discharge end;
ii. a perforated distributor plate positioned in the vessel and defining above the plate a material zone having an upstream heating section and a downstream cooling section and defining below the plate a heating compartment and a cooling compartment;
(b) delivering particulate matter feedstock to be processed into the delivery end of the vessel at a predetermined rate;
(c) delivering combustion gases upward through the perforations in the distributor plate from the heating compartment into the heating section;
(d) causing the feedstock to travel downstream in a suspended condition in a fluidizing air stream due to combustion gases delivered upward through the distributor plate;
(e) exposing the feedstock to the combustion gases for converting the feedstock into processed particulate matter;
(f) cooling the fluidized air stream of the processed particulate matter in the cooling section by delivering cooling air into the cooling compartment, through the perforations in the distributor plate and finally into the fluidized processed particulate matter in the cooling section; and
(g) discharging the processed particulate matter from the vessel from the discharge end.

15. A method for producing lightweight aggregates according to claim 14, wherein the step of delivering pressurized combustion gases comprises the steps of:
(a) blowing ambient air through a heat exchanger to preheat the air;
(b) inserting fuel into the air;
(c) igniting the fuel and air to create the combustion gases; and
(d) delivering resulting combustion gases to the heating compartment.

16. A method for producing lightweight aggregates according to claim 14, the method further comprising the steps of:
(a) diverting a stream of particles below a predetermined size into a particulate control system positioned outside of the vessel;
(b) filtering fine particulates out of the diverted stream of particulates in the particulate control system; and
(c) discharging the filtered stream through a blower.

17. A method for producing lightweight aggregates according to claim 16, wherein the step of filtering fine particles is performed by a cyclone apparatus utilizing vortex separation.

18. A method for producing lightweight aggregates according to claim 17, wherein the stream passes from the cyclone into a bag house which filters out additional particles of a finer granularity than the fine particles collected by the cyclone before discharging a filtered stream through the blower.

19. A method for producing lightweight aggregates according to claim 18, wherein the stream exiting the cyclone is cooled by a heat exchanger prior to entering the bag house.

20. A method for producing lightweight aggregates, comprising the steps of:
(a) providing:
i. an elongate vessel having a delivery end and a downstream particulate matter discharge end;
ii. a perforated distributor plate positioned in the vessel and defining above the plate a material zone having an upstream heating section and a downstream cooling section and defining below the plate a heating compartment and a cooling compartment;
(b) delivering particulate matter feedstock to be processed into the delivery end of the vessel at a predetermined rate;
(c) blowing ambient air through a heat exchanger to preheat the air;
(d) inserting fuel into the air;
(e) igniting the fuel and air to create combustion gases;
(f) delivering combustion gases upward through the perforations in the distributor plate from the heating compartment into the heating section;
(g) causing the feedstock to travel downstream in a suspended condition in a fluidizing air stream due to combustion gases delivered upward through the distributor plate;
(h) exposing the feedstock to the combustion gases for converting the feedstock into processed particulate matter;
(i) cooling the fluidized air stream of the processed particulate matter in the cooling section by delivering cooling air into the cooling compartment, through the perforations in the distributor plate and finally into the fluidized processed particulate matter in the cooling section; and discharging the processed particulate matter from the vessel from the discharge end.
